(19) United States
(12) Patent Application Publication
(10) Pub. No.: US 2004/0081238 A1
(43) Pub. Date: Apr. 29, 2004

(54) Asymmetric block shape modes for motion estimation

(76) Inventor: Manindra Parhy, Santa Clara, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/280,924

(22) Filed: Oct. 25, 2002

(51) Int. Cl. H04N 7/12

(52) U.S. Cl. 375/240.16

(57) ABSTRACT

An asymmetric layout is provided to partition a target macroblock of a target frame of a video image data into a plurality of sub-blocks. At least one of the plurality of sub-blocks has different amount of pixels than others of the plurality of sub-blocks. For each of the plurality of sub-blocks of the target macroblock, a search is conducted for a matched block having the least differences within a search area of a reference frame of the video image data.

### FIELD OF THE INVENTION

The invention relates generally to communication technology and, more particularly, to video compression technology.

### BACKGROUND OF THE INVENTION

Motion picture video sequences consist of a series of still pictures or “frames” that are sequentially displayed to provide the illusion of continuous motion. Each frame may be described as a two-dimensional array of picture elements, or “pixels”. Each pixel describes a particular point in the picture in terms of brightness and hue. Pixel information can be represented in digital form, or encoded, and transmitted digitally.

Video sequences contain a large amount of data and require large storage capacity and transmission bandwidth. However, this data contains considerable redundancies and therefore compression is possible. The main goal of video compression is to offer savings in transmission and storage resources. Digital video is compressed by reducing the redundancies in both spatial and temporal directions. Spatial redundancy is expressed by the existing correlation between neighboring pixels in one frame, while temporal redundancy is represented by the correlation between consecutive frames in the sequence.

One way to compress video data is to take advantage of the redundancy between neighboring frames of a video sequence. Since neighboring frames tend to contain similar information, describing the difference between frames typically requires less data than describing the new frame. If there is no motion between frames, for example, coding the difference (zero) requires less data than recoding the entire frame.

Motion estimation is the process of estimating the displacement between neighboring frames. Displacement is described as the motion vectors that give the best match between a specified region in the current frame and the corresponding displaced region in a previous or subsequent reference frame. The difference between the specified region in the current frame and the corresponding displaced region in the reference frame is referred to as “residue”.

In general, there are two known types of motion estimation methods used to estimate the motion vectors: pixel-recursive algorithms and block-matching algorithms. Pixel-recursive techniques predict the displacement of each pixel iteratively from corresponding pixels in neighboring frames. Block-matching algorithms, on the other hand, estimate the displacement between frames on a block-by-block basis and choose vectors that minimize the difference.

Motion information consists of vectors for forward predicted macroblocks, and vectors for bidirectionally predicted macroblocks which means vectors for backward predicted macroblocks and forward predicted macroblocks. The motion information associated with each macroblock is coded differentially with respect to the motion information present in the previous macroblock in the neighborhood. In this way a macroblock of pixels is predicted by a translation of a macroblock of pixels from a past or future picture. The difference between the source pixels and the predicted pixels is encoded and included in the corresponding bit stream. The decoder adds a correction term to the block of predicted pixels to produce the reconstructed block.

FIG. 1 shows a block diagram of a typical block-matching process. Current frame 120 is shown divided into blocks. Each block can be any size, however, in an MPEG (Motion Picture Expert Group) standard, for example, current frame 120 would typically be divided into 16×16-sized macroblocks. To code current frame 120, each block in current frame 120 is predicted from a block in a previous frame 110 or bidirectionally predicted from a block in previous frame 110 and a block in up coming frame 130. Predicting a block means finding a best matching block that has the least difference from the current block by some block matching criteria. The current block is coded in terms of its difference from the predicted block. In each iteration of a block-matching process, current block 100 is compared with similar-sized “candidate” blocks within search range 115 of preceding frame 110 or search range 135 of upcoming frame 130. The candidate block(s) of the preceding or upcoming frame that is determined to have the smallest difference with respect to current block 100 is selected as the reference block(s). Block 150 in FIG. 1 is shown as the reference block for block 100. The motion vectors and residues between reference block 150 and current block 100 are computed and coded.

Difference between blocks may be calculated using any one of several known criterions, either minimize error or maximize correlation. Because most correlation techniques are computationally intensive, error-calculating methods are more commonly used. Examples of error-calculating measures include mean square error (MSE), mean absolute distortion (MAD), and sum of absolute distortions (SAD). Among all, SAD is the most commonly used matching criterion.

A typical compression operation includes the elimination of spatial redundancy. Spatial redundancy is the redundancy within a picture. Because of the block-based nature of the motion compensation process, it was desirable to use a block-based method of reducing spatial redundancy, such as DCT (discrete cosine transform).

The DCT is an orthogonal transformation. Orthogonal transformations, because they have a frequency domain interpretation, are filter bank oriented. The DCT is also localized. That is, the encoding process samples on an 8×8 spatial window, which is sufficient to compute 64, transform coefficients or sub-bands. Another advantage of the DCT is that fast encoding and decoding algorithms are available. Additionally, the sub-band decomposition of the DCT is sufficiently well behaved to allow effective use of psycho visual criteria.

After transformation, many of the frequency coefficients are zero, especially the coefficients for high spatial frequencies. These coefficients are organized into a zigzag pattern, and converted into run-amplitude (runlevel) pairs. Each pair indicates the number of zero coefficients that follows and the amplitude of the non-zero coefficient. This is coded in a variable length code.

Motion estimation is used to reduce or even eliminate redundancy between pictures. Motion estimation exploits temporal redundancy by dividing the current picture into blocks, for example, macroblocks, and searching in previously transmitted pictures for a nearby block with similar content. Only the difference between the current block pels and the predicted block pels extracted from the reference picture is actually compressed for transmission and thereafter transmitted.

Motion compensated video coding is an efficient video compression technique. Motion compensated video coding exploits the temporal redundancy between successive video frames by motion estimation. Selected among different motion estimation techniques, block-based motion estimation was adopted in the MPEG-4 standard (a multimedia network standard of the Moving Pictures Expert Group), and the ITU/T H.263 video coding standard. Block-based motion estimation is efficient and easily implemented for both hardware and software. In block-based video coding, video frames are divided into blocks. Each block is associated with a vector (i.e., a motion vector) to describe the location of the block in the reference frame that provides the best match under some block distortion measure (BDM). The block in the reference frame that provides the best match is used to predict the current block in motion compensated video coding. By encoding the motion vectors and possibly the prediction residues, the video sequence is compressed with high compression efficiency because the entropy of the prediction residue plus that of the motion vector is lower than the entropy of the original video frame.

Traditionally, in video compression standards, such as MPEG, H263, or H.26L, a macroblock is uniformly divided into a plurality of basic smaller block shapes for motion estimation. For example, MPEG contains 16×16 and 8×8 block shapes. The latest approved H.26L draft contains 16×16, 8×8, 16×8, 8×16, 8×4, 4×8, and 4×4 block shapes for motion estimation. FIG. 2 shows examples of the above prior art block shapes.

However, one of the problems with the uniform division of macroblock is that it does not take into account the fact that the amount of motion present in the macroblock is not uniform across the macroblock. In some cases, more bits are spent than necessary to encode the macroblock. In other cases, more motion vectors are used than necessary.

### SUMMARY OF THE INVENTION

An asymmetric layout is provided to partition a target macroblock of a target frame of a video image data into a plurality of sub-blocks. At least one of the plurality of sub-blocks has different amount of pixels than others of the plurality of sub-blocks. For each of the plurality of sub-blocks of the target macroblock, a search is conducted for a matched block having the least differences within a search area of a reference frame of the video image data.

### BRIEF DESCRIPTION OF THE DRAWINGS

The invention is illustrated by way of example and not limitation in the figures of the accompanying drawings in which like references indicate similar elements.

FIG. 1 shows a diagram of a typical motion estimation which is used with one embodiment.

FIG. 2 shows block shapes used in prior art motion estimation.

FIG. 3 shows a block diagram of video compression in which one embodiment of asymmetric block modes may be used.

FIG. 4 shows a block diagram of an exemplary data processing system in which embodiments of asymmetric block modes may be used.

FIG. 5 shows exemplary block shapes used with one embodiment.

FIGS. 6A to 6c show diagrams of conventional motion estimation and FIG. 6d shows one embodiment.

FIG. 7 shows additional block shapes in accordance with another embodiment.

FIG. 8 shows a flow diagram illustrating an exemplary method performing motion estimation in accordance with one embodiment.

FIG. 9 shows a flow diagram illustrating an exemplary method performing motion estimation in accordance with another embodiment.

FIG. 10 shows a flow diagram illustrating an exemplary method performing motion estimation in accordance with yet another embodiment.

FIG. 11 shows a diagram illustrating an exemplary process to construct a block mode in accordance with one embodiment.

FIG. 12 shows a flow diagram illustrating an exemplary method of forming a block mode in accordance with one embodiment.

FIG. 13 shows a flow diagram illustrating an exemplary process for forming block modes in accordance with one embodiment.

FIG. 14 shows a flow diagram illustrating an exemplary process for video compression in accordance with one embodiment.

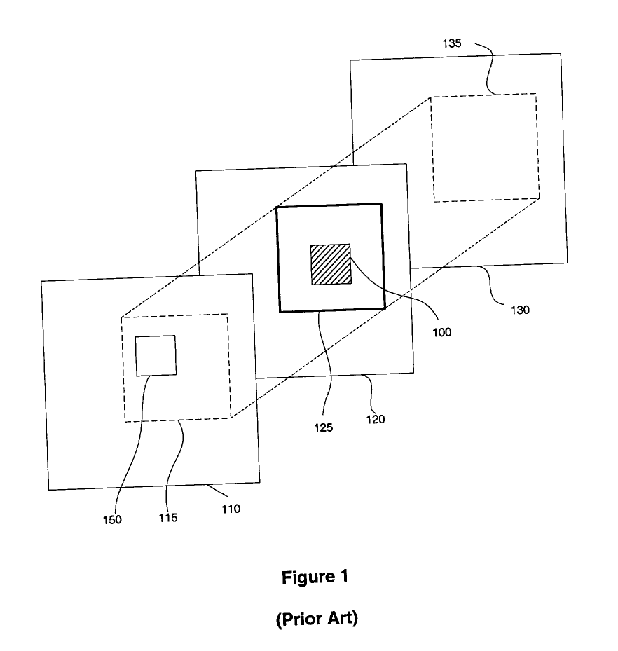

### DETAILED DESCRIPTION

In the following description, numerous details are set forth to provide a more thorough explanation of the invention. It will be apparent, however, to one skilled in the art, that the invention may be practiced without these specific details. In other instances, well-known structures and devices are shown in block diagram form, rather than in detail, in order to avoid obscuring the invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

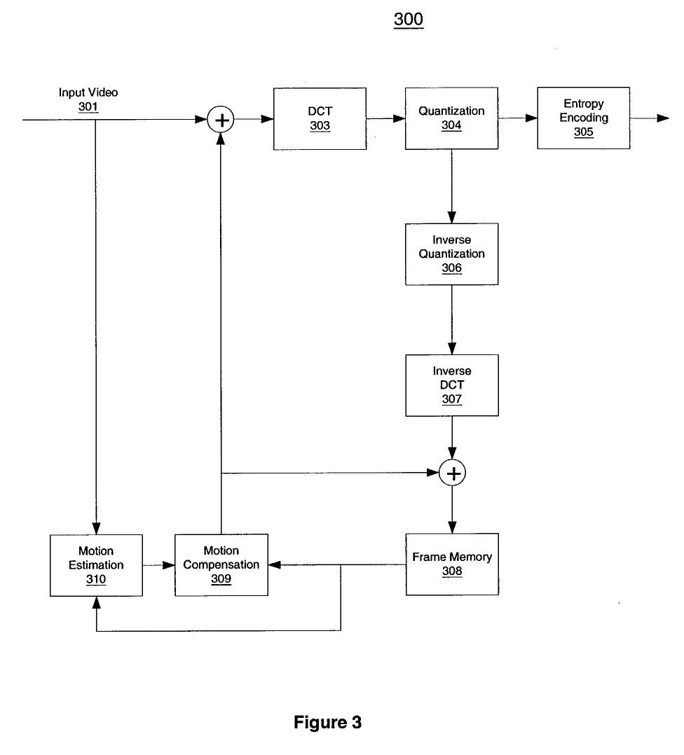

FIG. 3 shows a block diagram of an exemplary video encoding process in accordance with one embodiment. The encoding process may begin with some preprocessing which may include, but not limited to, color conversion, format translation (e.g., interlaced to progressive), pre-filtering and sub sampling. In one embodiment, the encoder 300 includes a discrete cosine transform (DCT) unit 303, a quantization unit 304, an entropy encoding unit 305, an inverse quantization unit 306, an inverse DCT unit 307, a motion estimation unit 310, a motion compensation unit 309, and a frame memory 308.

As shown in FIG. 3, in the encoding process, the images of the i^{th} picture and the i+1^{th} picture are processed in the encoder 300 to generate motion vectors which are the of form in which, for example, the i+1^{th} and subsequent pictures are encoded and transmitted. An input image 301 of a subsequent picture goes to the motion estimation unit 310 of the encoder. Motion vectors are formed as the output of the motion estimation unit 310. These vectors are used by the motion compensation unit 309 to retrieve macroblock data from previous and/or future pictures, referred to as “reference” data, for output by this unit. One output of the motion compensation unit 309 is negatively summed with the output from the motion estimation unit 310 and goes to the input of the DCT unit 303. The output of the DCT unit 303 is quantized in the quantization unit 304. The output of the quantization unit 304 is split into two outputs, one output goes to a downstream element for further compression and processing before transmission, such as to a run length encoder; the other output goes through reconstruction of the encoded macroblock of pixels for storage in frame memory 308. In the encoder shown for purposes of illustration, this second output goes through an inverse quantization unit 306 and an inverse DCT unit 307 to return a lossy version of the difference macroblock. This data is summed with the output of the motion compensation unit 309 and returns a lossy version of the original picture to the frame memory 308.

Entropy coding is the last stage in the encoding algorithm of video compression processing. It is a lossless compression stage following the quantization of the DCT coefficients. Entropy coding consists of two parts: run-length coding (RLC) and variable-length coding (VLC).

After quantization of the DCT coefficients, and since in general images tend to have low-pass spectrum, the non-zero DCT coefficients will tend to cluster at low frequencies and a large number of high frequency coefficients are likely to be zero. The quantized DCT coefficients may be ordered in a zigzag scan such that non-zero coefficients will tend to be sent first. There will normally be a large run of zero coefficients at the end of the scan. An end-of-block marker is usually used to eliminate the need to transmit these coefficients. Each AC coefficient is represented by its value and the run-length of zero valued coefficients that occur before it. The run/value combinations are mapped into code words. Usually these code words have a peaked distribution and are further compressed using VLC.

VLC is a lossless compression technique that can achieve a reduction in the average number of bits per code words by assigning shorter codes to code words having high probability of occurrence and longer codes to code words having lower probability. Typically, the code words representing the run/value combinations of the quantized DCT coefficients are coded using Huffman code. The code satisfies the prefix rule, which states that no code forms the prefix of any other, that is, the code is uniquely decodable once its starting point is known.

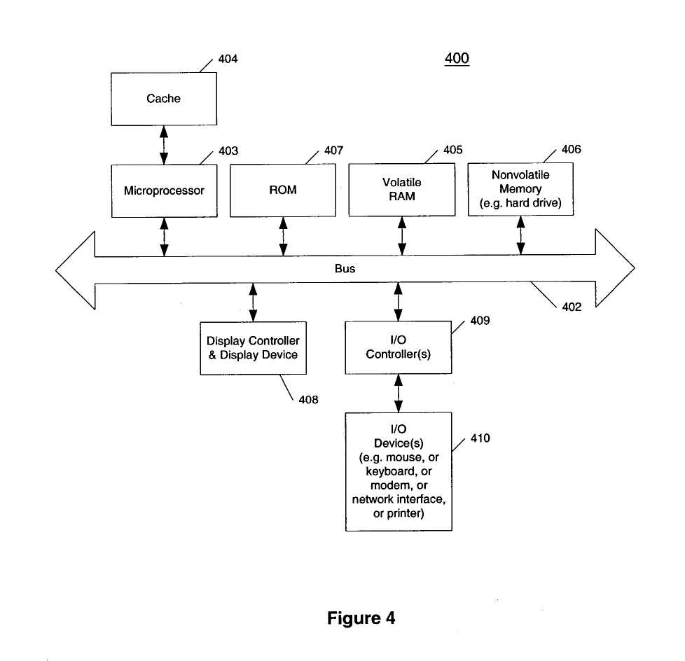

FIG. 4 shows one example of a typical computer system, which may be used with the invention to perform the above processes. Note that while FIG. 4 illustrates various components of a computer system, it is not intended to represent any particular architecture or manner of interconnecting the components as such details are not germane to the present invention. It will also be appreciated that network computers and other data processing systems (e.g., a personal digital assistant), which have fewer components or perhaps more components, may also be used with the present invention. The computer system of FIG. 4 may, for example, be an Apple Macintosh computer or a personal digital assistant (PDA).

As shown in FIG. 4, the computer system 400, which is a form of a data processing system, includes a bus 402 which is coupled to a microprocessor 403 and a ROM 407 and volatile RAM 405 and a non-volatile memory 406. The microprocessor 403, which may be a G3 or G4 microprocessor from Motorola, Inc. or IBM is coupled to cache memory 404 as shown in the example of FIG. 4. Alternatively, the microprocessor 403 may be an UltraSPARC microprocessor from Sun Microsystems, Inc. Other processors from other vendors may be utilized. The bus 402 interconnects these various components together and also interconnects these components 403, 407, 405, and 406 to a display controller and display device 408 and to peripheral devices such as input/output (I/O) devices which may be mice, keyboards, modems, network interfaces, printers and other devices which are well known in the art. Typically, the input/output devices 410 are coupled to the system through input/output controllers 409. The volatile RAM 405 is typically implemented as dynamic RAM (DRAM) which requires power continually in order to refresh or maintain the data in the memory. The non-volatile memory 406 is typically a magnetic hard drive or a magnetic optical drive or an optical drive or a DVD RAM or other type of memory systems which maintain data even after power is removed from the system. Typically, the non-volatile memory will also be a random access memory although this is not required. While FIG. 4 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 402 may include one or more buses connected to each other through various bridges, controllers and/or adapters as are well known in the art. In one embodiment the I/O controller 409 includes a USB (Universal Serial Bus) adapter for controlling USB peripherals.

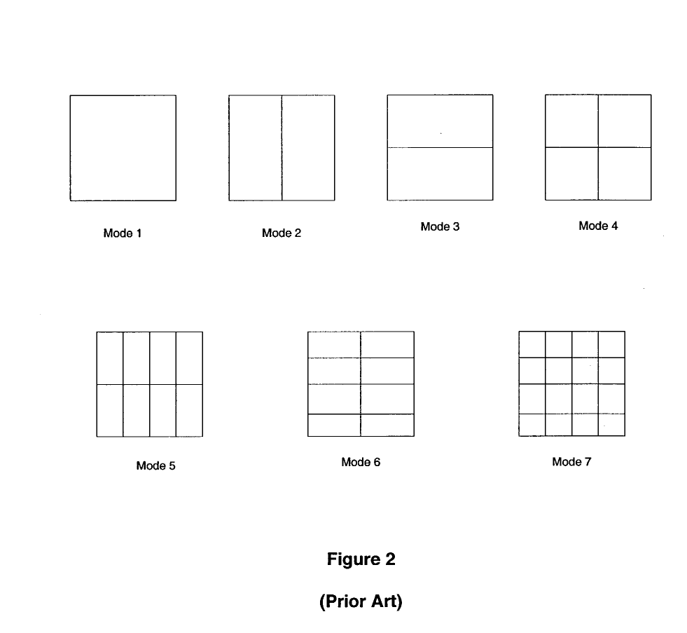

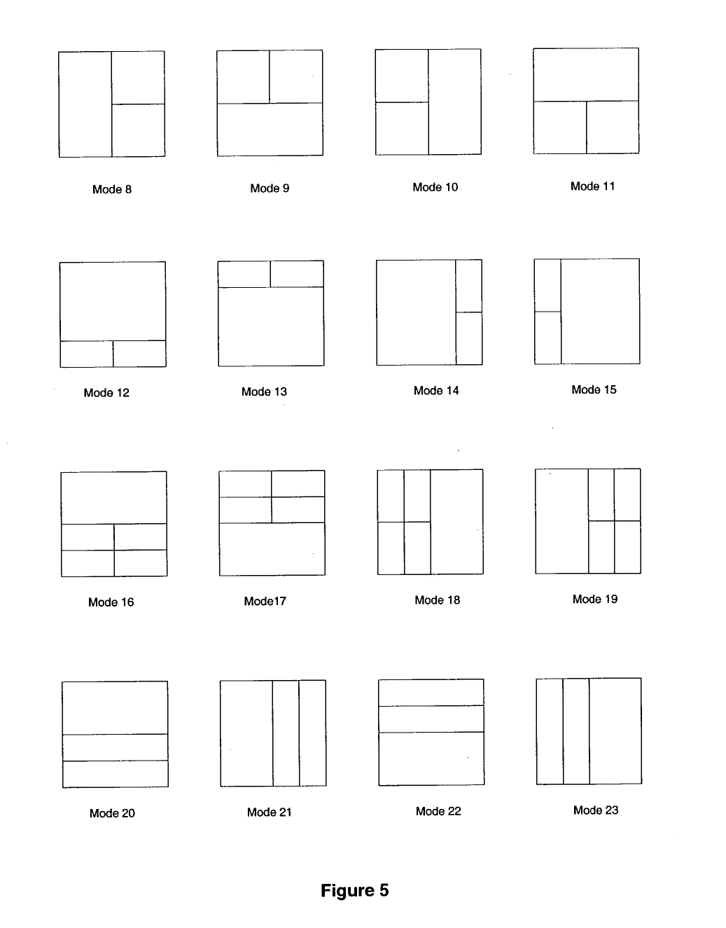

FIG. 5 shows a block diagram of exemplary block shapes of macroblocks in accordance with one embodiment. The modes 8-11 may be used conjunction with modes 1-7 of FIG. 2 defined by H.26L as discussed above. In one embodiment, these modes are selected by the video encoder such as video encoder 300 of FIG. 3. These shapes are construed by taking into account of the fact that the amount of motion present in the macroblock is not uniform across the macroblock.

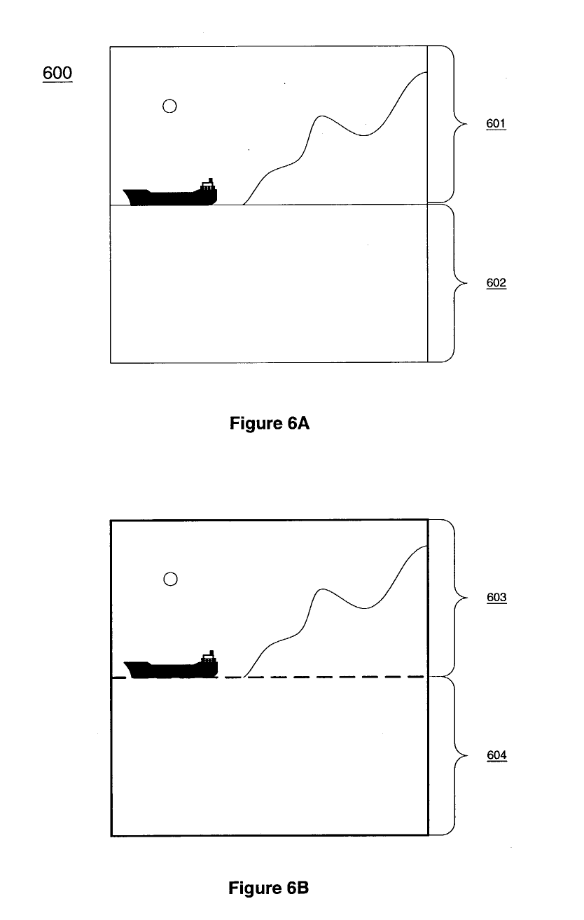

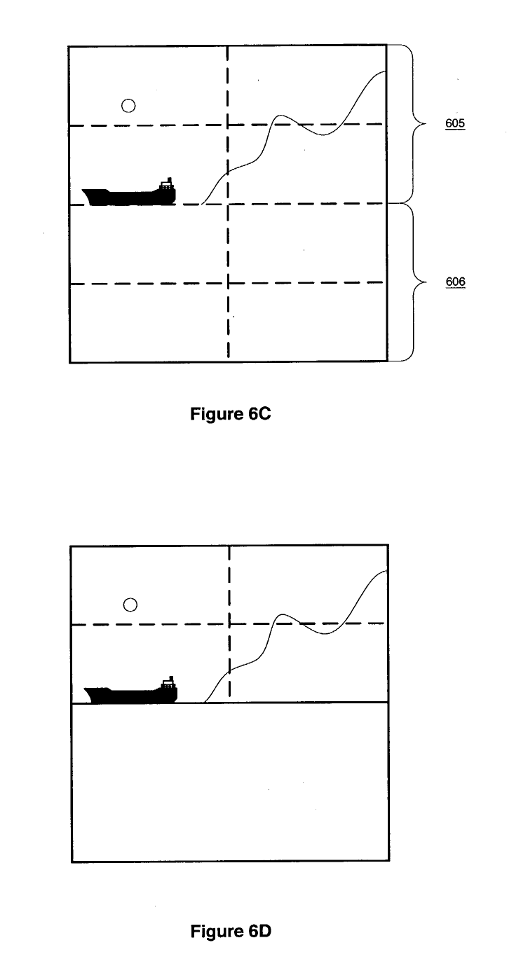

For example, as shown in FIG. 6A and for illustration purposes, a macroblock 600 contains a sun, a ship, and a mountain in the upper half 601 of the macroblock. In addition, the macroblock 600 contains an ocean in the lower half 602 of the macroblock. As shown in FIG. 6A, there is very little motion complexity present in the lower half 602 of the macroblock 600, while there is higher motion complexity (e.g., there is different amount of motion present in different parts) in the upper half 601 of the macroblock 600. If mode 6 of FIG. 2 is chosen to represent the encoding condition, as shown in FIG. 6C, a lot of motion vector bits are wasted for the lower half 606 of the macroblock because there is very little motion complexity. It would be more appropriate to send one vector instead of four vectors. If mode 3 of FIG. 2 is chosen, as shown in FIG. 6B, a lot of bits on DCT coefficients are spent because there are varying energy densities across the upper half 603 of the macroblock, while there is little motion complexity in the lower half 604. As a result, in both cases (e.g., FIGS. 6B and 6C), more bits than necessary are spent to encode the macroblock.

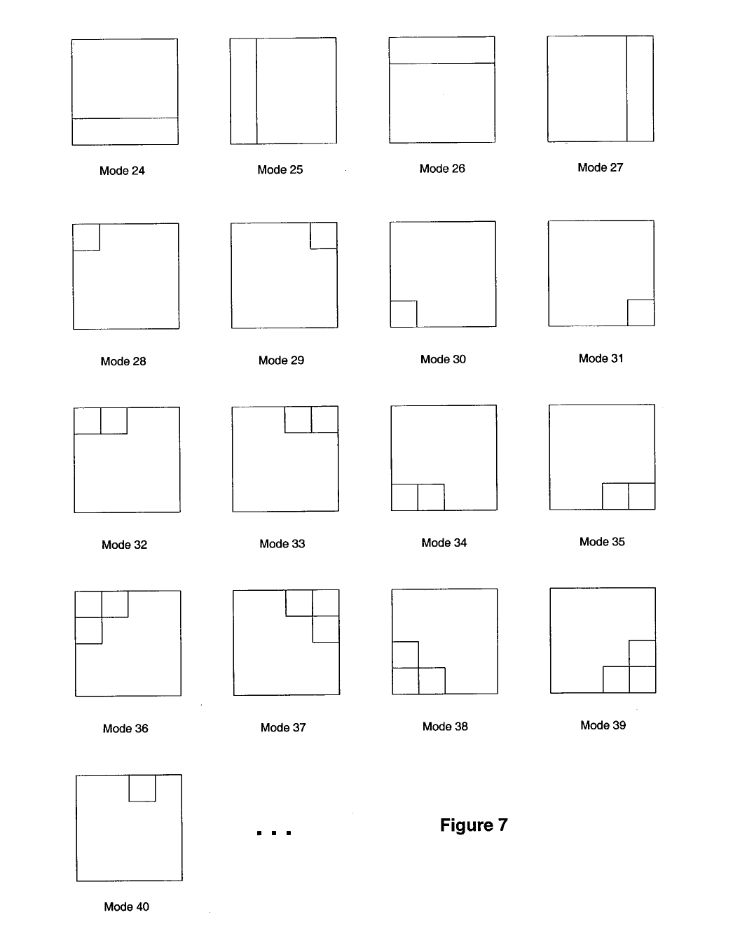

However, according to one embodiment, if mode 17 of FIG. 5 is chosen, as shown in FIG. 6D, it would take optimal number of bits to encode the motion vector information and the DCT transform coefficients. Alternatively, mode 9 of FIG. 5 may also be used. It will be appreciated that the shapes of the modes are not limited to those illustrated in this application. It will be apparent to an ordinary skilled in the art that other asymmetric shapes, such as those shown in FIG. 7, may be used.

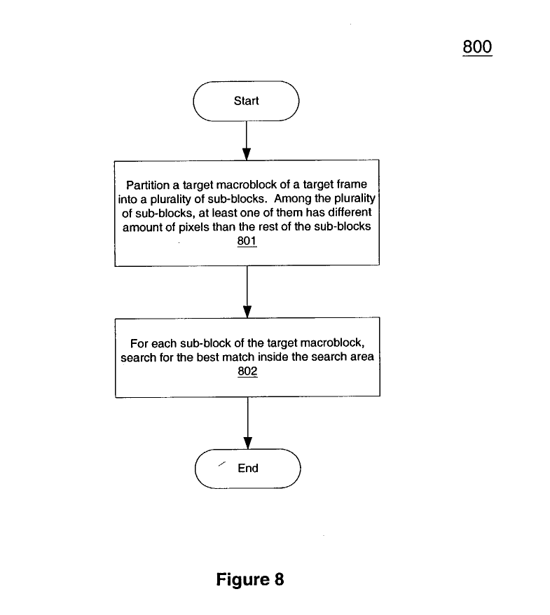

FIG. 8 shows a flow diagram illustrating an exemplary method 800 of performing motion estimation in accordance with one embodiment. Referring to FIG. 8, once a target macroblock is chosen in a target frame, at block 801, the target macroblock is partitioned into a plurality of sub-blocks. In one embodiment, the target macroblock is partitioned in accordance with an asymmetric layout. In one embodiment, the asymmetric layout is selected from, but not limited to, those listed in FIGS. 5 and 7. Other asymmetric layouts may be implemented by an ordinary skilled in the art. In one embodiment, the target macroblock is divided into a first and a second sub-blocks. The first sub-block is smaller than the second sub-block. The first sub-block is further divided into a plurality of third sub-blocks while the second sub-block remains undivided. In one embodiment, at least one of the pluralities of sub-blocks includes a polygonal shape which is not a square or rectangle and each of the angles of the polygonal shape is multiples of 90 degree. In an alternative embodiment, the target macroblock is divided into a first and a second sub-blocks using a straight line and one of the first and second sub-blocks is further divided into a plurality of third sub-blocks while the other sub-block remains undivided. At block 802, for each of sub-block of the target macroblock, a search is conducted within a search area of a reference frame for a best match. In one embodiment, the search is performed using a sum of absolute difference (SAD) operation of the target macroblock and reference macroblocks in the search area.

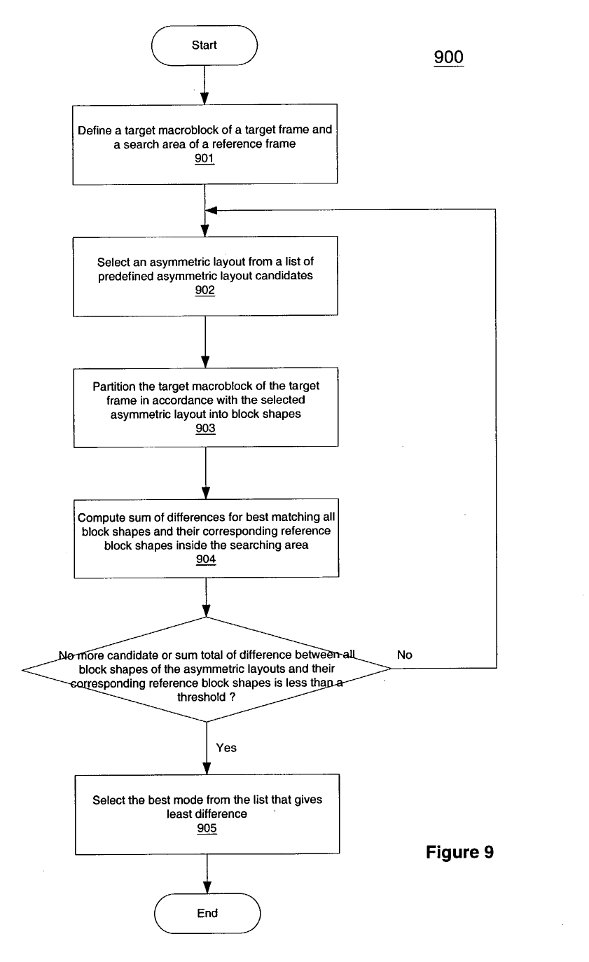

FIG. 9 shows a flow diagram illustrating an exemplary method 900 of performing motion estimation in accordance with one embodiment. At block 901, a target macroblock is selected in a target frame and a search area is selected in a reference frame. At block 902, the system selects an asymmetric layout from a list of predefined asymmetric layout candidates. In one embodiment, the asymmetric layout is selected from, but not limited to, those listed in FIGS. 5 and 7. Other layouts may be implemented by an ordinary skilled in the art. At block 903, the system partitions the target macroblock of the target frame is partitioned into a plurality of sub-blocks using the selected asymmetric layout. In one embodiment, the target macroblock is divided into a first and a second sub-blocks. The first sub-block is smaller than the second sub-block. The first sub-block is further divided into a plurality of third sub-blocks while the second sub-block remains undivided. In one embodiment, at least one of the pluralities of sub-blocks includes a polygonal shape which is not a square or rectangle and each of the angles of the polygonal shape is multiples of 90 degree. In an alternative embodiment, the target macroblock is divided into a first and a second sub-blocks using a straight line and one of the first and second sub-blocks is further divided into a plurality of third sub-blocks while the other sub-block remains undivided. At block 904, the system computes the difference between all block shapes of the target macroblock and corresponding block shapes inside the search area. In one embodiment, a SAD operation is utilized during the computation. Alternatively, other operations, such as MAD or MSE operations, may be utilized. The above processes continue until there are no more candidates in the list, or alternatively the sun total of differences between all block shapes of the macroblock and one of the reference block shapes of the search area is less than a predefined threshold. In which case, at block 905, a best block mode is selected from the list that has the least differences

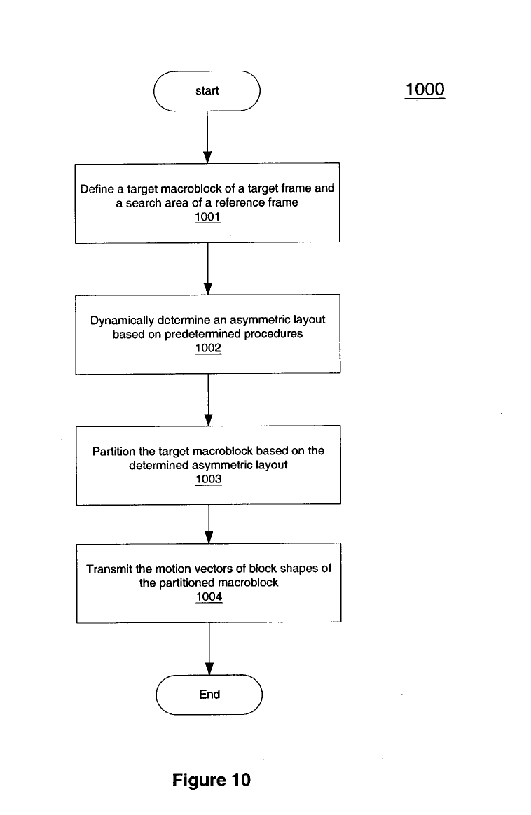

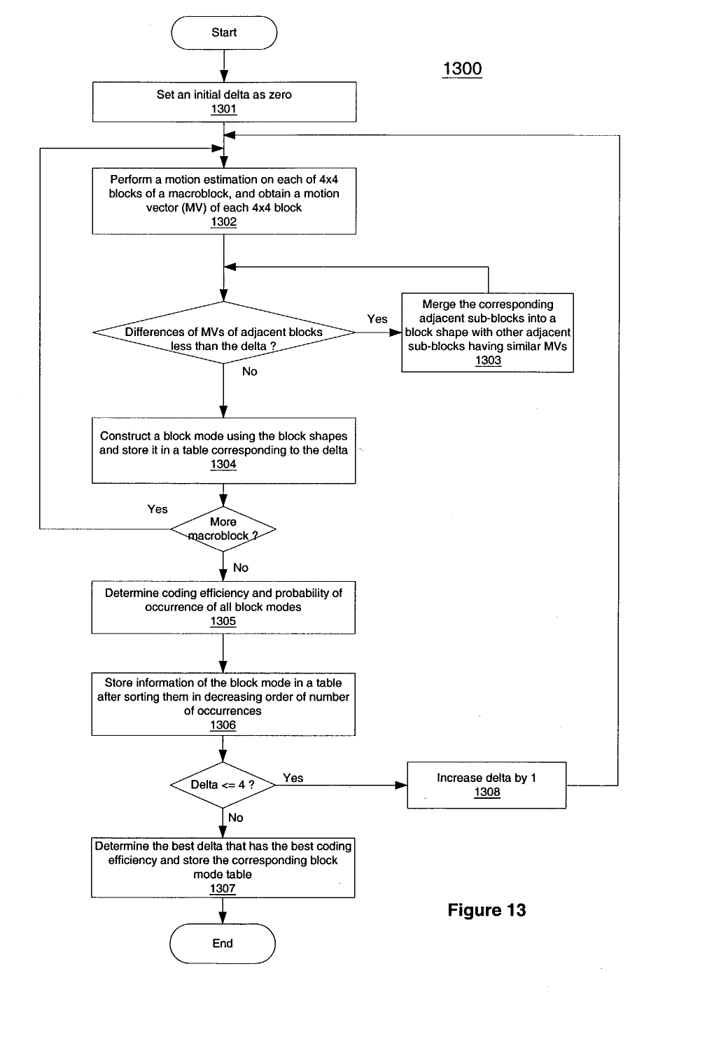

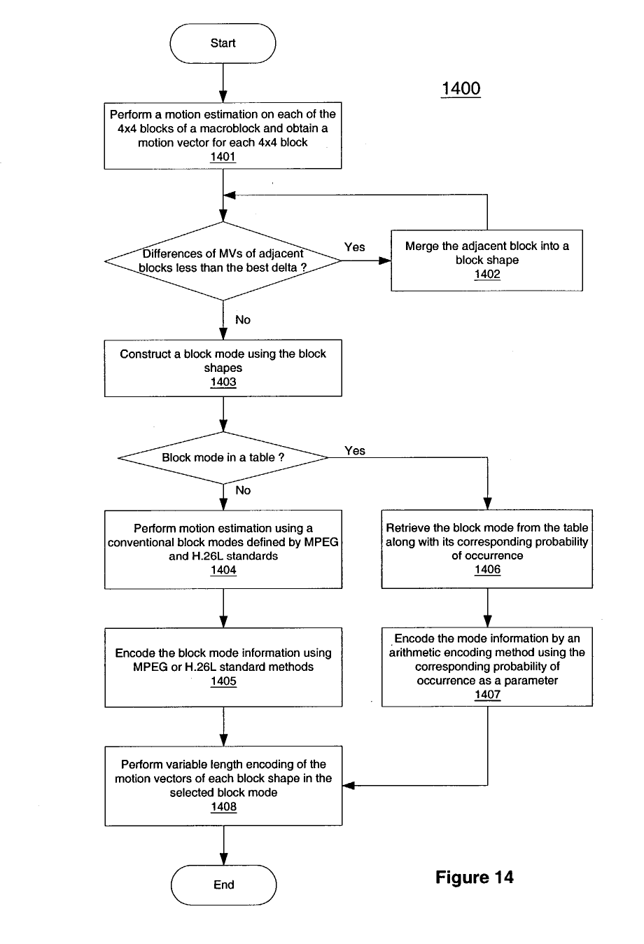

FIG. 10 shows a flow diagram illustrating an exemplary method 1000 of performing motion estimation in accordance with one embodiment. At block 1001, a target macroblock is defined in a target frame and a search area is defined in a reference frame. At block 1002, the system dynamically determines an asymmetric layout based on a predetermined procedure such as, for example, process 900 of FIG. 9 or process 1300 of FIG. 13. At block 1003, the system partitions the target macroblock into a plurality of sub-blocks based on the determined asymmetric layout. At block 1004, the system transmits the motion vectors of the block shapes of the partitioned macroblock.

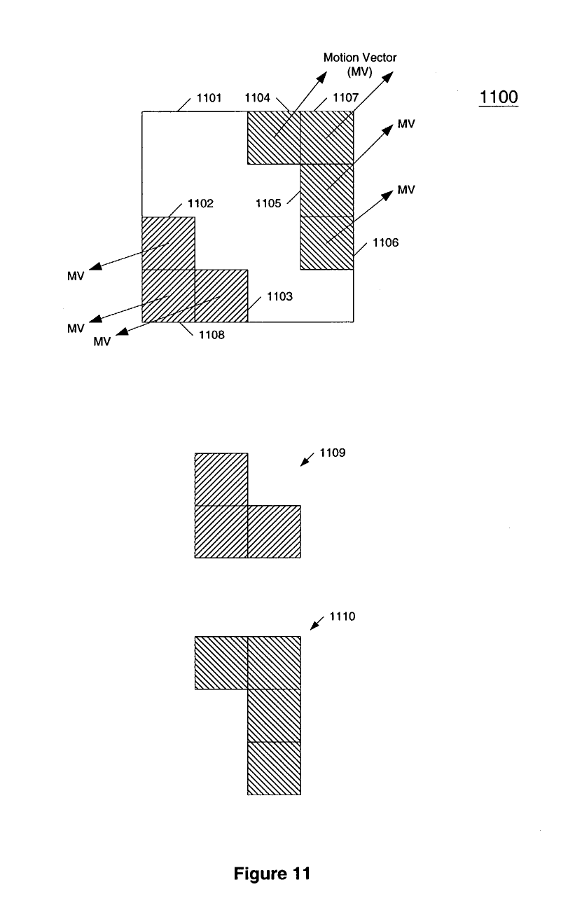

FIG. 11 shows a block diagram illustrating an exemplary process 1100 to construct a block mode in accordance with one embodiment. The system initially performs motion estimation for each of the predefined sub-blocks in a macro block. In one embodiment, the predefined sub-blocks are 4×4 blocks. In this example, motion estimation is performed on each of the 4×4 sub-blocks, such as sub-blocks 1102 to 1108, of the macroblock 1101. As a result, the motion vector of each sub-block is obtained. The adjacent or neighboring sub-blocks having similar motion vectors may be grouped to form a block shape. In this example, sub-blocks 1102-1103 and 1108 have similar motion vectors and they may be grouped to form a block mode having a block shape of 1109. Similarly, sub-blocks 1104-1107 have similar motion vectors and they may be used as block shapes to form a block mode having a shape 1110. The above processes may be repeated for numerous video frames to construct a list of block mode candidates. In this way, the motion complexity of the macroblock is taken into account.

In one embodiment, each block shape associated with the block mode is characterized by its height, width, and position inside the corresponding macroblock, such as (pos_x, pos_y, width, height). For example, block mode 8 of FIG. 5 may contain three block shapes: block shape 1 (0,0,8,16), block shape 2 (8,0,8,8), and block shape 3 (8, 8, 8, 8). In one embodiment, the block modes in FIG. 5 may be described as follows:

| Block | |
|---|---|
| Mode | Block Shapes |
| Mode 8: | (0, 0, 8, 16), (8, 0, 8, 8), (8, 8, 8, 8) |
| Mode 9: | (0, 0, 8, 8), (8, 0, 8, 8), (0, 8, 16, 8) |
| Mode 10: | (0, 0, 8, 8), (8, 0, 8, 16), (0, 8, 8, 8) |
| Mode 11: | (0, 0, 16, 8), (0, 8, 8, 8), (8, 8, 8, 8) |
| Mode 12: | (0, 0, 16, 12), (0, 12, 8, 4), (8, 12, 8, 4) |
| Mode 13: | (0, 0, 8, 4), (8, 0, 8, 4), (0, 4, 16, 12) |
| Mode 14: | (0, 0, 12, 16), (12, 0, 4, 8), (12, 8, 4, 8) |
| Mode 15: | (0, 0, 4, 8), (4, 0, 12, 16), (0, 8, 4, 8) |
| Mode 16: | (0, 0, 16, 8), (0, 8, 8, 4), (8, 8, 8, 4), (0, 12, 8, 4), (8, 12, 8, 4) |
| Mode 17: | (0, 0, 8, 4), (8, 0, 8, 4), (0, 4, 8, 4), (8, 4, 8, 4),(0, 8, 16, 8) |
| Mode 18: | (0, 0, 4, 8), (4, 0, 4, 8), (8, 0, 8, 16), (0, 8, 4, 8), (4, 8, 4, 8) |
| Mode 19: | (0, 0, 8, 16), (8, 0, 4, 8), (12, 0, 4, 8), (8, 8, 4, 8), (12, 8, 4, 8) |
| Mode 20: | (0, 0, 16, 8), (0, 8, 16, 4), (0, 12, 16, 4) |
| Mode 21: | (0, 0, 8, 16), (8, 0, 4, 16), (12, 0, 4, 16) |
| Mode 22: | (0, 0, 16, 4), (0, 4, 16, 4), (0, 8, 16, 8) |
| Mode 23: | (0, 0, 4, 16), (4, 0, 4, 16), (8, 0, 8, 16) |

In one embodiment, the block modes in FIG. 7 may be described as follows:

| Block Mode | Block Shapes |
|---|---|
| Mode 24: | (0, 12, 16, 4), Blockshape_last |
| Mode 25: | (0, 0, 4, 16), Blockshape_last |
| Mode 26: | (0, 0, 16, 4), Blockshape_last |
| Mode 27: | (12, 0, 4, 16), Blockshape_last |
| Mode 28: | (0, 0, 4, 4), Blockshape_ast |
| Mode 29: | (12, 0, 4, 4), Blockshape_last |
| Mode 30: | (0, 12, 4, 4), Blockshape_last |
| Mode 31: | (12, 12, 4, 4), Blockshape_last |
| Mode 32: | (0, 0, 4, 4), (4, 0, 4, 4), Blockshape_last |
| Mode 33: | (8, 0, 4, 4), (12, 0, 4, 4), Blockshape_last |
| Mode 34: | (0, 12, 4, 4), (4, 12, 4, 4), Blockshape_last |
| Mode 35: | (8, 12, 4, 4), (12, 12, 4, 4), Blockshape_last |
| Mode 36: | (0, 0, 4, 4), (4, 0,4, 4), (0, 4, 4, 4), Blockshape_last |
| Mode 37: | (8, 0, 4, 4), (12, 0,4, 4), (12, 4, 4, 4), Blockshape_last |
| Mode 38: | (0, 8, 4, 4), (0,12, 4, 4), (4, 12, 4, 4), Blockshape_last |
| Mode 39: | (12, 8, 4, 4), (8, 12, 4, 4), (12, 12, 4, 4), Blockshape_last |

Where Blockshape_last is a remaining area of the macroblock excluding block shapes listed. For example, the Blockshape_last of mode 24 is the remaining area of the macroblock excluding the block shape of (0,12,16,4). In an alternative embodiment, the block modes may be one of those satisfying (pos_x, pos_y, 4, 4), Blockshape_last, where pos_x, pos_y is one of the value selected from {0,4,8,12}.

Coding efficiency and probability of occurrence of each block mode are computed. The information of probability of occurrence is stored in a lookup table categorized by the block mode. In addition, a similarity threshold (e.g., best delta) of motion vectors is determined for which the block mode is selected gives the best coding efficiency.

Subsequently, according to one embodiment, during a normal video compression, the system performs motion estimation for each 4×4 sub-blocks of a macroblock of a current frame and obtain its respective motion vector. If differences of the motion vectors of the neighboring sub-blocks are less than the best delta, the corresponding sub-blocks may be merged to form a block shape. The newly created block shapes are subsequently used to create a block mode. The system checks the table previously constructed above to determine whether the table contains the newly created block mode. If it does, the system retrieves the corresponding block mode from the table and encodes the block mode information using the corresponding probability of the block mode retrieved from the table.

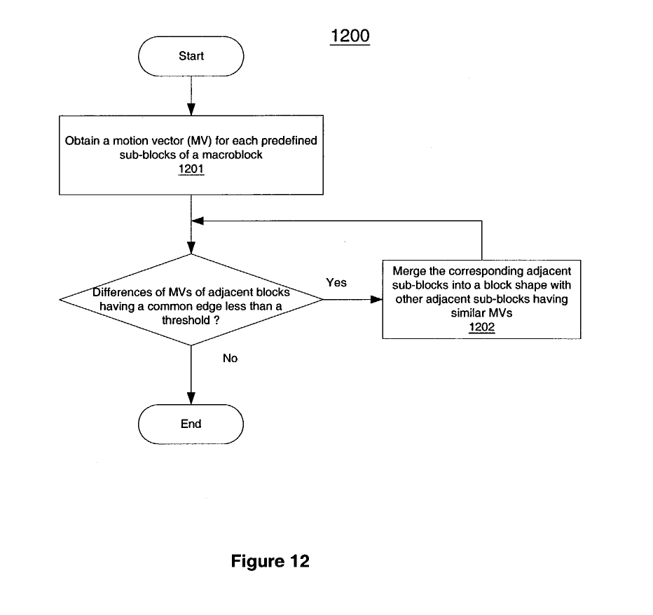

FIG. 12 shows a flow diagram illustrating an exemplary method 1200 of forming a block mode in accordance with one embodiment. In one embodiment, the method 1200 includes obtaining a motion vector (MV) for each of a plurality of predefined sub-blocks of a macroblock, and generating a block mode using neighboring sub-blocks of the plurality of predefined sub-blocks as block shapes, if differences of the corresponding MVs are less than a threshold.

Referring to FIG. 12, at block 1201, the system performs motion estimation for each of a plurality of predefined sub-blocks of a macroblock and obtains its corresponding motion vector. In one embodiment, the predefined sub-blocks are 4×4 blocks and the macroblock is a 16×16 block. At block 1202, the system merges the neighboring or adjacent sub-blocks having similar MVs with other adjacent sub-blocks having similar MVs. In one embodiment, the neighboring or adjacent sub-blocks have a common edge to one another. In one embodiment, the similarity is determined whether the differences of the motion vectors are less than a threshold value. It would be apparent to an ordinary skilled in the art that the above processes may be repeated numerous times to form a variety of block modes. In one embodiment, the block modes generated using the above processes are stored in a table which is stored in a memory location, such as nonvolatile memory 406 of the data processing system 400 in FIG. 4. In addition, the probability of occurrence and the block shapes associated with the block mode may be stored in the table associated with the block mode.

FIG. 13 shows a flow diagram illustrating an exemplary process 1300 for generating a block mode table in accordance with one embodiment. Referring to FIG. 13, at block 1301, the system initially sets a delta as zero. At block 1302, the system performs motion estimation on each of 4×4 sub-blocks of a plurality of macroblocks of a plurality of video frames, and obtains a motion vector for each of the 4×4 sub-blocks. At block 1303, the system merges the adjacent sub-blocks into a block shape with other adjacent sub-blocks having similar MVs, if the differences of their respective motion vectors of adjacent or neighboring sub-blocks having a common edge are less than the current delta. At block 1304, the system constructs a block mode using the block shapes and stores it in a table corresponding to the current delta. The above processes continue until all of the macroblocks in a video sequence have been processed. At block 1305, the system calculates the coding efficiency and the probability of occurrence of the newly created block mode. At block 1306, the system stores this information of the block mode in a table. In one embodiment, the information stored in a table includes probability of the occurrence of the block mode and all of the block shapes associated with the block mode. At block 1308, the system increases the delta by one and repeats the above processes until the delta reaches a predetermined threshold, such as four. Once the delta reaches four, at block 1307, the system determines the best delta that has the best coding efficiency and this best delta is to be used as the delta for any video compression process. It would be appreciated that the forgoing operations may be performed for a number of video sequences to achieve better block modes and best delta.

FIG. 14 shows a flow diagram illustrating an exemplary process 1400 for video compression in accordance with one embodiment. Referring to FIG. 14, once the table containing a plurality of block mode candidates is defined using a block mode forming process, such as process 1300 illustrated in FIG. 13, at block 1401, during a normal video compression process, the system performs a motion estimation on each of the 4×4 sub-blocks of a macroblock and obtains a motion vector for each of the 4×4 sub-blocks. At block 1402, the system merges some of the adjacent 4×4 sub-blocks having a common edge into a block shape if their respective motion vectors are similar. In one embodiment, the block mode is created using some of the adjacent 4×4 sub-blocks having a common edge as block shapes if differences of the corresponding motion vectors are less than a threshold determined through a block mode formation process, such as the best delta determined by the process 1300 illustrated in FIG. 13. Once all the block shapes are generated, the system constructs a block mode using the block shapes. The system then checks whether the block mode candidate table, which is created through previous block mode formation process (e.g., process 1300 of FIG. 13), contains the newly created block mode. If the table does not contain the newly created block mode, at block 1404, the system performs motion estimation using a conventional block modes defined by a conventional standard, such as MPEG or H.26L. At block 1405, the system encodes the block mode information using MPEG or H.26L method and at block 1408, performs variable length encoding of the motion vectors of each block shape in the selected block mode.

If the table contains the selected block mode, at block 1406, the system retrieves the block mode information from the table, along with its corresponding probability of occurrence. At block 1407, the system encodes the block mode information through an arithmetic encoding method using the corresponding probability of occurrence of the block mode as a parameter. At block 1408, the system performs variable length encoding of the motion vectors of each block shape in the selected block mode.

Although particular embodiments of the invention have been shown and described, it will be apparent to those of ordinary skill in the art that changes and modifications can be made without departing from the embodiments of the invention in its broader aspects. For example, a variety of programming languages can be used to implement the motion estimation technique in accordance with the teachings of the embodiments of the invention, such as the well-known C/C++ or JAVA programming languages. Also, embodiments of the invention can be used with a variety of multimedia communication environments, such as the well-known MPEG protocols (e.g., MPEG-2, MPEG-4 or MPEG-7 protocol) or a variety of other video communication or multimedia communication protocols, such as H.26L protocol. Therefore, the pending claims are to encompass within their scope all such changes and modifications that fall within the true scope of the invention.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method for motion estimation of video compression, comprising:
partitioning a target macroblock of a target frame into a plurality of sub-blocks, wherein at least one of the plurality of sub-blocks has a different amount of pixels than others of the plurality of sub-blocks; and
searching, for each of the plurality of sub-blocks of the target macroblock, a matched block having the least differences within a search area of a reference frame.

2. The method of claim 1, wherein the partitioning comprises:
selecting an asymmetric layout from a list of predefined asymmetric layout candidates, wherein the plurality of sub-blocks are partitioned based on the selected asymmetric layout; and
computing differences between the sub-blocks of the target macroblock and reference blocks of the reference frame.

3. The method of claim 2, wherein the searching further comprises designating a best block mode from the list having the least differences when all asymmetric layout candidates have been utilized.

4. The method of claim 2, wherein the partitioning further comprises repeating selecting the asymmetric layout, partitioning according to the layout, and computing until the differences are less than a predetermined threshold.

5. The method of claim 1, wherein the partitioning comprises:
dividing the target macroblock into a first sub-block and a second sub-block, wherein the first sub-block is smaller than the second sub-block; and
dividing the first sub-block into a plurality of third sub-blocks, while the second sub-block remains undivided.

6. The method of claim 5, wherein at least one of the plurality of sub-blocks has a polygonal shape with more than four sides, wherein all angles of the polygonal shape are multiple of 90 degree.

7. The method of claim 5, wherein the first sub-block is on a periphery of the macroblock.

8. The method of claim 5, wherein the partitioning comprises:
dividing the target macroblock into a first sub-block and a second sub-block using a straight line; and
dividing the first sub-block into a plurality of third sub-blocks, while the second sub-block remains undivided.

9. The method of claim 1, further comprising performing at least one of the following operations:
obtaining a motion vector between the target macroblock and the reference macroblock;
performing motion compensation using the motion vector;
encoding the motion vector and the difference into a bit stream data;
transforming the bit stream data into a frequency domain;
performing quantization on the transformed data; and
performing entropy encoding on the transformed data.

10. The method of claim 1, wherein the target macroblock is partitioned with a block mode having a plurality of block shapes, each block shape associated with the block mode is characterized by (pos_x, pos_y, width, height), and the target macroblock is partitioned using a block mode selected from the group consisting of:
(0,0,8,16),(8,0,8,8),(8,8,8,8);
(0,0,8,8),(8,0,8,8),(0,8,16,8);
(0,0,8,8),(8,0,8,16),(0,8,8,8);
(0,0,16,8),(0,8,8,8),(8,8,8,8);
(0,0,16,12),(0,12,8,4),(8,12,8,4);
(0,0,8,4),(8,0,8,4),(0,4,16,12);
(0,0,12,16),(12,0,4,8),(12,8,4,8);
(0,0,4,8),(4,0,12,16),(0,8,4,8);
(0,0,16,8),(0,8,8,4),(8,8,8,4),(0,12,8,4),(8,12,8,4);
(0,0,8,4),(8,0,8,4),(0,4,8,4),(8,4,8,4),(0,8,16,8);
(0,0,4,8),(4,0,4,8),(8,0,8,16),(0,8,4,8),(4,8,4,8);
(0,0,8,16),(8,0,4,8),(12,0,4,8),(8,8,4,8),(12,8,4,8);
(0,0,16,8),(0,8,16,4),(0,12,16,4);
(0,0,8,16),(8,0,4,16),(12,0,4,16);
(0,0,16,4),(0,4,16,4),(0,8,16,8); and
(0,0,4,16),(4,0,4,16),(8,0,8,16).

11. The method of claim 1, wherein the target macroblock is partitioned with a block mode having a plurality of block shapes, each block shape associated with the block mode is characterized by (pos_x, pos_y, width, height), and the target macroblock is partitioned using a block mode selected from the group consisting of:
(0,12,16,4), Blockshape_last;
(0,0,4,16), Blockshape_last;
(0,0,16,4), Blockshape_last;
(12,0,4,16), Blockshape_last;
(0,0,4,4), Blockshape_last;
(12,0,4,4), Blockshape_last;
(0,12,4,4), Blockshape_last;
(12,12,4,4), Blockshape_last;
(0,0,4,4),(4,0,4,4), Blockshape_last;
(8,0,4,4),(12,0,4,4), Blockshape_last;
(0,12,4,4),(4,12,4,4), Blockshape_last;
(8,12,4,4),(12,12,4,4), Blockshape_last;
(0,0,4,4),(4,0,4,4),(0,4,4,4), Blockshape_last;
(8,0,4,4),(12,0,4,4),(12,4,4,4), Blockshape_last;
(0,8,4,4),(0,12,4,4),(4,12,4,4), Blockshape_last; and
(12,8,4,4),(8,12,4,4),(12,12,4,4), Blockshape_last,
wherein Blockshape_last is a remaining area of the target macroblock excluding block shapes listed.

12. The method of claim 1, wherein the target macroblock is partitioned into a configuration defined as (pos_x, pos_y, 4, 4), Blockshape_last, wherein the pos_x and pos_y are selected from the values of 0, 4, 8, and 12.

13. A method for determining a block mode, comprising:
obtaining a motion vector (MV) for each of a plurality of predefined sub-blocks of a macroblock; and
generating a block mode using adjacent sub-blocks of the plurality of predefined sub-blocks as block shapes if differences of the corresponding MVs of the adjacent sub-blocks are less than a threshold.

14. The method of claim 13, wherein the plurality of predefined sub-blocks are 4×4 blocks and the first macroblock is a 16×16 block.

15. A method for defining a set of block modes, comprising:
obtaining a motion vector (MV) for each of a plurality of predefined sub-blocks of a first macroblock;
generating a first block mode using adjacent sub-blocks of the plurality of predefined sub-blocks as block shapes if differences of the corresponding MVs of the adjacent sub-blocks are less than a first threshold;
repeating the obtaining and the generating for all macroblocks in a video sequence to generate a set of second block modes; and
computing a coding efficiency and a probability of occurrence of the second block modes.

16. The method of claim 15, further comprising performing at least one of the following operations:
performing motion compensation using the motion vector;
encoding the motion vector and the difference into a bit stream data;
transforming the bit stream data into a frequency domain;
performing quantization on the transformed data; and
performing entropy encoding on the transformed data.

17. The method of claim 15, further comprising storing information regarding the second block modes in a memory.

18. The method of claim 15, wherein the information regarding the second block modes includes:
a probability of occurrence of the second block modes; and
block shapes associated with the second block modes.

19. The method of claim 15, further comprising:
adjusting the first threshold;
repeating the obtaining, the generating, and the computing;
determining a second threshold and corresponding set of third block modes; and
storing the second threshold and the third block modes in a table.

20. The method of claim 19, wherein the adjusting and repeating are performed on a plurality of video sequences to generate a third threshold and corresponding set of fourth block modes, and wherein the third threshold and the fourth block modes are stored in a table.

21. A method for motion estimation of video compression, comprising:
obtaining a motion vector (MV) for each of the plurality of predefined sub-blocks of a plurality of macroblocks of a video frame;
generating a block mode using adjacent sub-blocks of the plurality of predefined sub-blocks as block shapes, if differences of the corresponding MVs are less than a threshold;
retrieving information regarding the block mode from the memory, if the memory contains the block mode; and
performing encoding of the block mode based on the information retrieved from the memory.

22. The method of claim 21, wherein the plurality of predefined sub-blocks are 4×4 blocks and the second macroblock is a 16×16 block.

23. The method of claim 21, further comprising performing at least one of the following operations:
performing motion compensation based on a result of the motion estimation;
encoding information of motion estimation and motion compensation into a bit stream data;
transforming the bit stream data into a frequency domain;
performing quantization on the transformed data; and
performing entropy encoding on the transformed data.

24. A machine-readable medium having executable code to cause a machine to perform a method, the method comprising:
partitioning a target macroblock of a target frame into a plurality of sub-blocks, wherein at least one of the plurality of sub-blocks has different amount of pixels than others of the plurality of sub-blocks; and
searching, for each of the plurality of sub-blocks of the target macroblock, a matched block having the least differences within a search area of a reference frame.

25. The machine-readable medium of claim 24, wherein the partitioning comprises:
selecting an asymmetric layout from a list of predefined asymmetric layout candidates, wherein the plurality of sub-blocks are partitioned based on the selected asymmetric layout; and
computing differences between the sub-blocks of the target macroblock and reference blocks of the reference frame.

26. The machine-readable medium of claim 25, wherein the searching further comprises designating a best mode from the list that gives the least differences when all asymmetric layout candidates have been utilized.

27. The machine-readable medium of claim 25, wherein the partitioning further comprises repeating selecting the asymmetric layout, partitioning according to the layout, and computing until the differences are less than a predetermined threshold.

28. The machine-readable medium of claim 24, wherein the partitioning comprises:
dividing the target macroblock into a first sub-block and a second sub-block, wherein the first sub-block is smaller than the second sub-block; and
dividing the first sub-block into a plurality of third sub-blocks, while the second sub-block remains undivided.

29. The machine-readable medium of claim 28, wherein at least one of the plurality of sub-blocks has a polygonal shape with more than four sides, wherein all angles of the polygonal shape are multiple of 90 degree.

30. The machine-readable medium of claim 28, wherein the first sub-block is on the periphery of the macroblock.

31. The machine-readable medium of claim 28, wherein the partitioning comprises:
dividing the target macroblock into a first sub-block and a second sub-block using a straight line; and
dividing the first sub-block into a plurality of third sub-blocks, while the second sub-block remains undivided.

32. The machine-readable medium of claim 24, further comprising performing at least one of the following operations:
obtaining a motion vector between the target macroblock and the reference macroblock;
performing motion compensation using the motion vector;
encoding the motion vector and the difference into a bit stream data;
transforming the bit stream data into a frequency domain;
performing quantization on the transformed data; and
performing entropy encoding on the transformed data.

33. The machine-readable medium of claim 24, wherein the target macroblock is partitioned with a block mode having a plurality of block shapes, each block shape associated with the block mode is characterized by (pos_x, pos_y, width, height), and the target macroblock is partitioned using block mode selected from the group consisting of:
(0,0,8,16),(8,0,8,8),(8,8,8,8);
(0,0,8,8),(8,0,8,8),(0,8,16,8);
(0,0,8,8),(8,0,8,16),(0,8,8,8);
(0,0, 16,8),(0,8,8,8),(8,8,8,8);
(0,0,16,12),(0,12,8,4),(8,12,8,4);
(0,0,8,4),(8,0,8,4),(0,4,16,12);
(0,0,12,16),(12,0,4,8),(12,8,4,8);
(0,0,4,8),(4,0,12,16),(0,8,4,8);
(0,0,16,8),(0,8,8,4),(8,8,8,4),(0,12,8,4),(8,12,8,4);
(0,0,8,4),(8,0,8,4),(0,4,8,4),(8,4,8,4),(0,8,16,8);
(0,0,4,8),(4,0,4,8),(8,0,8,16),(0,8,4,8),(4,8,4,8);
(0,0,8,16),(8,0,4,8),(12,0,4,8),(8,8,4,8),(12,8,4,8);
(0,0,16,8),(0,8,16,4),(0,12,16,4);
(0,0,8,16),(8,0,4,16),(12,0,4,16);
(0,0,16,4),(0,4,16,4),(0,8,16,8); and
(0,0,4,16), (4,0,4,16), (8,0,8,16).

34. The machine-readable medium of claim 24, wherein the target macroblock is partitioned with a block mode having a plurality of block shapes, each block shape associated with the block mode is characterized by (pos_x, pos_y, width, height), and the target macroblock is partitioned using a block mode selected from the group consisting of:
(0,12,16,4), Blockshape_last;
(0,0,4,16), Blockshape_last;
(0,0,16,4), Blockshape_last;
(12,0,4,16), Blockshape_last;
(0,0,4,4), Blockshape_last;
(12,0,4,4), Blockshape_last;
(0,12,4,4), Blockshape_last;
(12,12,4,4), Blockshape_last;
(0,0,4,4),(4,0,4,4), Blockshape_last;
(8,0,4,4),(12,0,4,4), Blockshape_last
(0,12,4,4),(4,12,4,4), Blockshape_last;
(8,12,4,4),(12,12,4,4), Blockshape_last;
(0,0,4,4),(4,0,4,4),(0,4,4,4), Blockshape_last;
(8,0,4,4),(12,0,4,4),(12,4,4,4), Blockshape_last;
(0,8,4,4),(0,12,4,4),(4,12,4,4), Blockshape_last; and
(12,8,4,4),(8,12,4,4),(12,12,4,4), Blockshape_last,
wherein Blockshape_last is a remaining area of the target macroblock excluding block shapes listed.

35. The machine-readable medium of claim 24, wherein the target macroblock is partitioned into a configuration defined as (pos_x, pos_y, 4, 4), Blockshape_last wherein the pos_x and pos_y are selected from the values of 0, 4, 8, and 12.

36. A machine-readable medium having executable code to cause a machine to perform a method, the method comprising:
obtaining a motion vector (MV) for each of a plurality of predefined sub-blocks of a macroblock; and
generating a block mode using adjacent sub-blocks of the plurality of predefined sub-blocks as block shapes if differences of the corresponding MVs of the adjacent sub-blocks are less than a threshold.

37. The machine-readable medium of claim 36, wherein the plurality of predefined sub-blocks are 4×4 blocks and the first macroblock is a 16×16 block.

38. A machine-readable medium having executable code to cause a machine to perform a method, the method comprising:
obtaining a motion vector (MV) for each of a plurality of predefined sub-blocks of a first macroblock;
generating a first block mode using adjacent sub-blocks of the plurality of predefined sub-blocks as block shapes if differences of the corresponding MVs of the adjacent sub-blocks are less than a first threshold;
repeating the obtaining and the generating for all macroblocks in a video sequence to generate a set of second block modes; and
computing a coding efficiency and a probability of occurrence of the second block modes.

39. The machine-readable of claim 38, wherein the method further comprises performing at least one of the following operations:
performing motion compensation using the motion vector;
encoding the motion vector and the difference into a bit stream data;
transforming the bit stream data into a frequency domain;
performing quantization on the transformed data; and
performing entropy encoding on the transformed data.

40. The machine-readable of claim 38, wherein the method further comprises storing information regarding the second block modes in a memory.

41. The machine-readable of claim 38, wherein the information regarding the second block modes includes:
a probability of occurrence of the second block modes; and
block shapes associated with the second block modes.

42. The machine-readable of claim 38, wherein the method further comprises:
adjusting the first threshold;
repeating the obtaining, the generating, and the computing;
determining a second threshold and corresponding set of third block modes; and
storing the second threshold and the third block modes in a table.

43. The machine-readable of claim 42, wherein the adjusting and repeating are performed on a plurality of video sequences to generate a third threshold and corresponding set of fourth block modes, and wherein the third threshold and the fourth block modes are stored in a table.

44. A machine-readable medium having executable code to cause a machine to perform a method, the method comprising:
obtaining a motion vector (MV) for each of the plurality of predefined sub-blocks of a plurality of macroblocks of a video frame;
generating a block mode using adjacent sub-blocks of the plurality of predefined sub-blocks as block shapes, if differences of the corresponding MVs are less than a threshold;
retrieving information regarding the block mode from the memory, if the memory contains the block mode; and
performing encoding of the block mode based on the information retrieved from the memory.

45. The machine-readable medium of claim 44, wherein the plurality of predefined sub-blocks are 4×4 blocks and the second macroblock is a 16×16 block.

46. The machine-readable medium of claim 44, wherein the method further comprises performing at least one of the following operations:
performing motion compensation based on a result of the motion estimation;
encoding information of motion estimation and motion compensation into a bit stream data;
transforming the bit stream data into a frequency domain;
performing quantization on the transformed data; and
performing entropy encoding on the transformed data.

47. An apparatus, comprising:
means for partitioning a target macroblock of a target frame into a plurality of sub-blocks, wherein at least one of the plurality of sub-blocks has different amount of pixels than others of the plurality of sub-blocks; and
searching, for each of the plurality of sub-blocks of the target macroblock, a matched block having the least differences within a search area of a reference frame.

48. A data processing system, comprising:
a processor; and
a memory coupled to the processor to store instructions that causes the processor to:
partition a target macroblock of a target frame into a plurality of sub-blocks, wherein at least one of the plurality of sub-blocks has different amount of pixels than others of the plurality of sub-blocks; and
search, for each of the plurality of sub-blocks of the target macroblock, a matched block having the least differences within a search area of a reference frame.

49. An apparatus, comprising:
means for obtaining a motion vector (MV) for each of a plurality of predefined sub-blocks of a macroblock; and
means for generating a block mode using adjacent sub-blocks of the plurality of predefined sub-blocks as block shapes if differences of the corresponding MVs of the adjacent sub-blocks are less than a threshold.

50. A data processing system, comprising:
a processor; and
a memory coupled to the processor to store instructions that causes the processor to:
obtain a motion vector (MV) for each of a plurality of predefined sub-blocks of a macroblock; and
generate a block mode using adjacent sub-blocks of the plurality of predefined sub-blocks as block shapes, if differences of the corresponding MVs of the adjacent sub-blocks are less than a threshold.

51. An apparatus, comprising:
means for obtaining a motion vector (MV) for each of a plurality of predefined sub-blocks of a first macroblock;
means for generating a first block mode using adjacent sub-blocks of the plurality of predefined sub-blocks as block shapes if differences of the corresponding MVs of the adjacent sub-blocks are less than a first threshold;
means for repeating the obtaining and the generating for all macroblocks in a video sequence to generate a set of second block modes; and
means for computing a coding efficiency and a probability of occurrence of the second block modes.

52. A data processing system, comprising:
a processor; and
a memory coupled to the processor to store instructions that causes the processor to:
obtain a motion vector (MV) for each of a plurality of predefined sub-blocks of a first macroblock;
generate a first block mode using adjacent sub-blocks of the plurality of predefined sub-blocks as block shapes, if differences of the corresponding MVs of the adjacent sub-blocks are less than a first threshold;
repeat the obtaining and the generating for all macroblocks in a video sequence to generate a set of second block modes; and
compute a coding efficiency and a probability of occurrence of the second block modes.

53. An apparatus, comprising:
means for obtaining a motion vector (MV) for each of the plurality of predefined sub-blocks of a plurality of macroblocks of a video frame;
means for generating a block mode using adjacent sub-blocks of the plurality of predefined sub-blocks as block shapes if differences of the corresponding MVs are less than a threshold;
means for retrieving information regarding the block mode from the memory, if the memory contains the block mode; and
means for performing encoding of the block mode based on the information retrieved from the memory.

54. A data processing system, comprising:
a processor; and
a memory coupled to the processor to store instructions that causes the processor to:
obtain a motion vector (MV) for each of the plurality of predefined sub-blocks of a plurality of macroblocks of a video frame;
generate a block mode using adjacent sub-blocks of the plurality of predefined sub-blocks as block shapes, if differences of the corresponding MVs are less than a threshold;
retrieve information regarding the block mode from the memory, if the memory contains the block mode; and
perform encoding of the block mode based on the information retrieved from the memory.
